(19) United States
(12) Patent Application Publication
(10) Pub. No.: US 2006/0158959 A1
(43) Pub. Date: Jul. 20, 2006

(54) Machine for making ice cream

(76) Inventor: Huang-Ming Huang, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/034,762

(22) Filed: Jan. 14, 2005

(51) Int. Cl. B01F 7/20

(52) U.S. Cl. 366/251

(57) ABSTRACT

A machine includes a securing seat, a rechargeable battery, a charger, and a stir mechanism for stirring ice cream materials with; the stir mechanism is fitted on the securing seat, and includes a control unit, a gear set, several blades joined to a central shank, and a motor, which is electrically connected to the control unit, and connected to a first one of the gear set at a shaft thereof; the central shank is joined to a last one of the gear set at inner end such that the central shank will rotate when the motor is running; the rechargeable battery is connected to the control unit to be used as power source for the motor while the charger is connected to the rechargeable battery such that the rechargeable battery will be charged when a power converter is connected to both the charger and a wall socket.

### BACKGROUND OF THE INVENTION

1. Field of the Invention

The present invention relates to a seat of a machine for making ice cream, more particularly one, which is equipped with a rechargeable battery, and a charger for charging the rechargeable battery with so that a user doesn't have to change the battery when energy of the battery runs out.

2. Brief Description of the Prior Art

Referring to FIGS. 4 and 5, a conventional machine for making ice cream includes a securing seat 10, a stir mechanism 20, and a battery 30. The stir mechanism 20 includes a housing 201, a motor 202, a gear set 203, a control unit 204, and several blades 207, which are joined to a central shank 206. The battery 30 is fitted in the control unit 204 to provide power to the control unit 204. The motor 202, the gear set 203, and the control unit 204 are held in the housing 201, and the control unit 204 is electrically connected to the motor 202 to control the motor 202. An output shaft 205 of the motor 202 is connected to a first one of the gear set 203.

To use the machine, first the housing 201 is fitted on the securing seat 10, and the central shank 206 is inserted in the housing 201 and connected to a last one of the gear set 203 at an inner end thereof such that the blades 207 are arranged outside the housing 201, and such that the central shank 206 will rotate when the motor 202 is powered. Next, the securing seat 10 is fitted over an opening of a container 40 with the central shank 206 and the blades 207 being passed into the container 40, in which container 40 ice cream materials are held. Therefore, the blades 207 will move to stir the ice cream materials held in the container 40 when the motor 202 is powered. Finally, the stirred ice cream materials are put into a freezer to become ice cream.

However, the above machine isn't very convenient to use because the user has to open the housing 201 of the stir mechanism 20 to change the battery 30 when the battery 30 runs out of energy.

### SUMMARY OF THE INVENTION

It is a main object of the invention to provide an improvement on a machine for making ice cream to overcome the above disadvantage.

The machine of the invention includes a rechargeable battery, a charger, and a stir mechanism for stirring ice cream materials with. The stir mechanism includes a control unit, a gear set, several blades joined to a central shank, and a motor, which is electrically connected to the control unit, and connected to a first one of the gear set at a shaft thereof. The central shank is joined to a last one of the gear set at inner end such that the central shank will rotate when the motor is running. And, the rechargeable battery is connected to the control unit to be used as power source for the motor while the charger is connected to the rechargeable battery for charging the rechargeable battery with. Therefore, the user doesn't have to change the battery when energy of the battery runs out.

### BRIEF DESCRIPTION OF THE DRAWINGS

The present invention will be better understood by referring to the accompanying drawings, wherein:

FIG. 1 is an exploded perspective view of the machine for making ice cream according to the present invention,

FIG. 2 is a sectional view of the machine in the present invention,

FIG. 3 is a sectional view of the machine of the invention in use,

FIG. 4 is an exploded perspective view of the conventional machine for making ice cream as described in Background, and

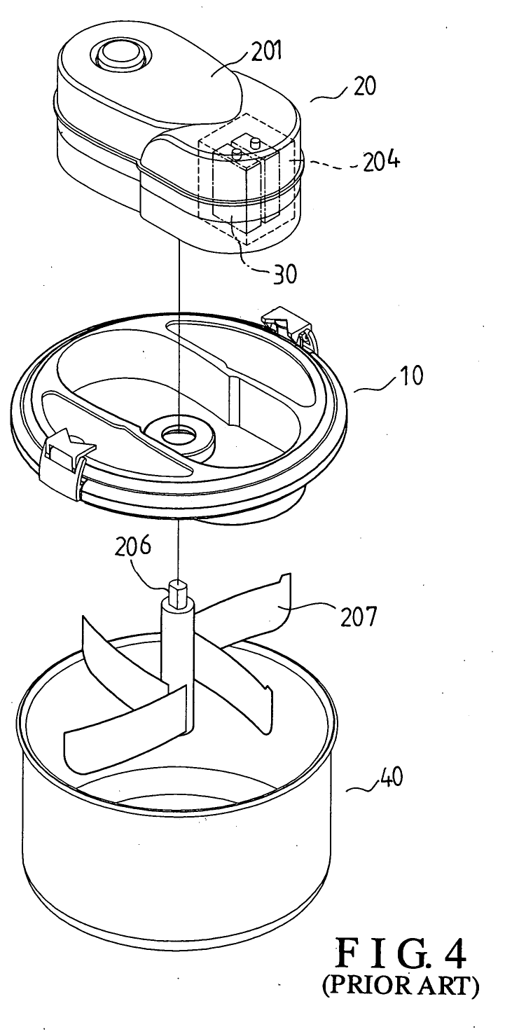

FIG. 5 is a sectional view of the conventional machine.

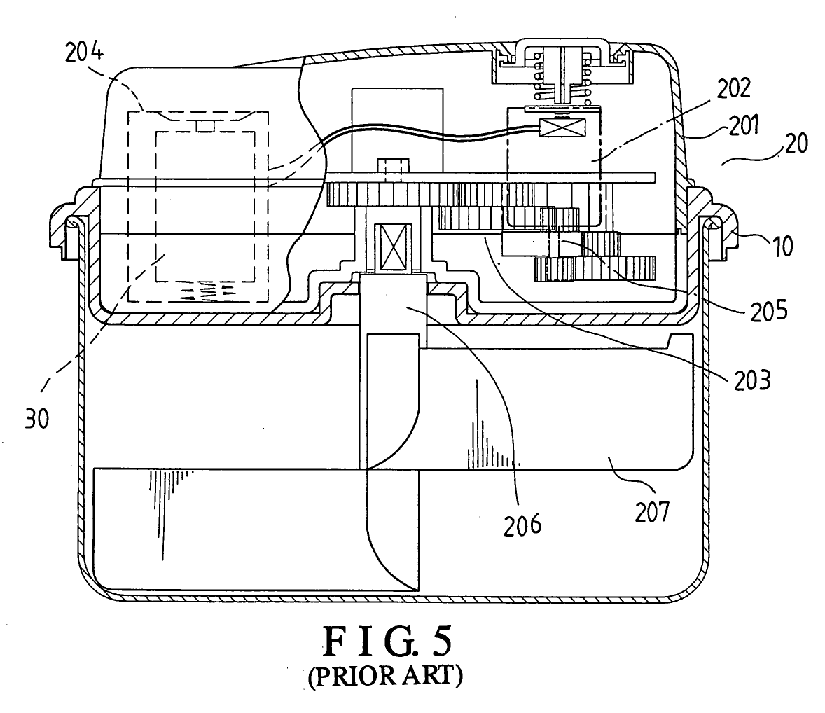

### DETAILED DESCRIPTION OF THE PREFERRED EMBODIMENTS

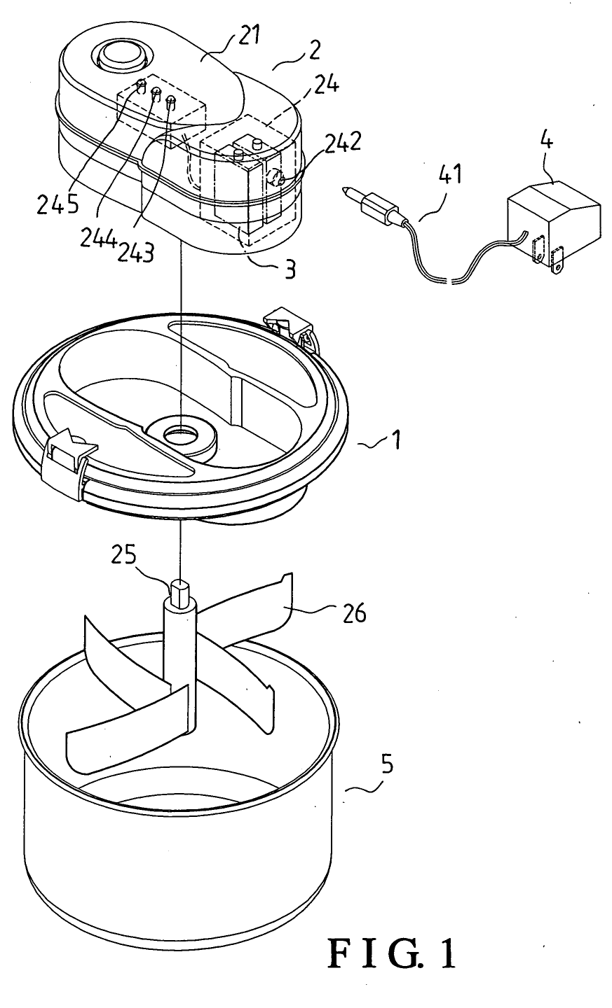

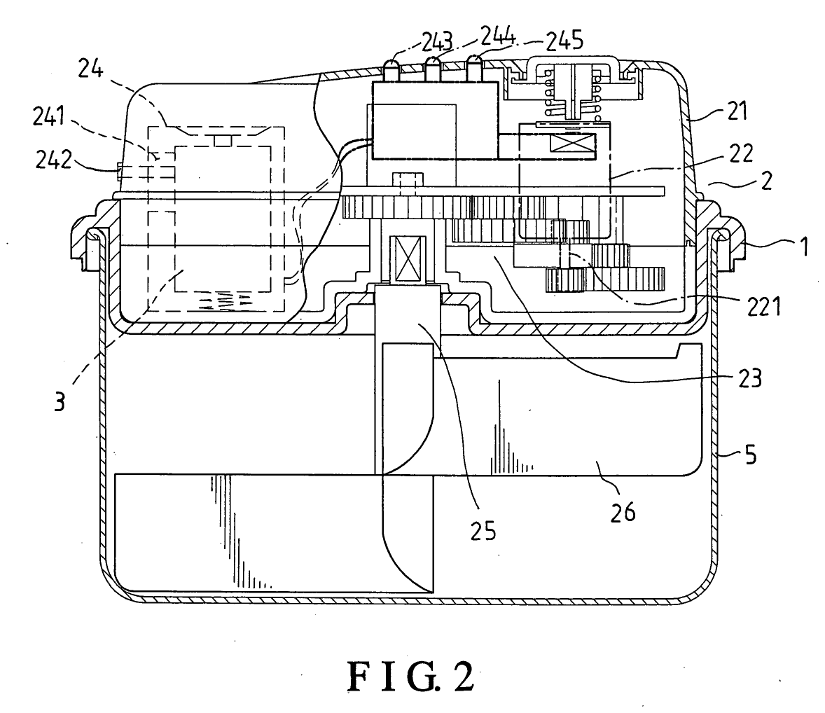

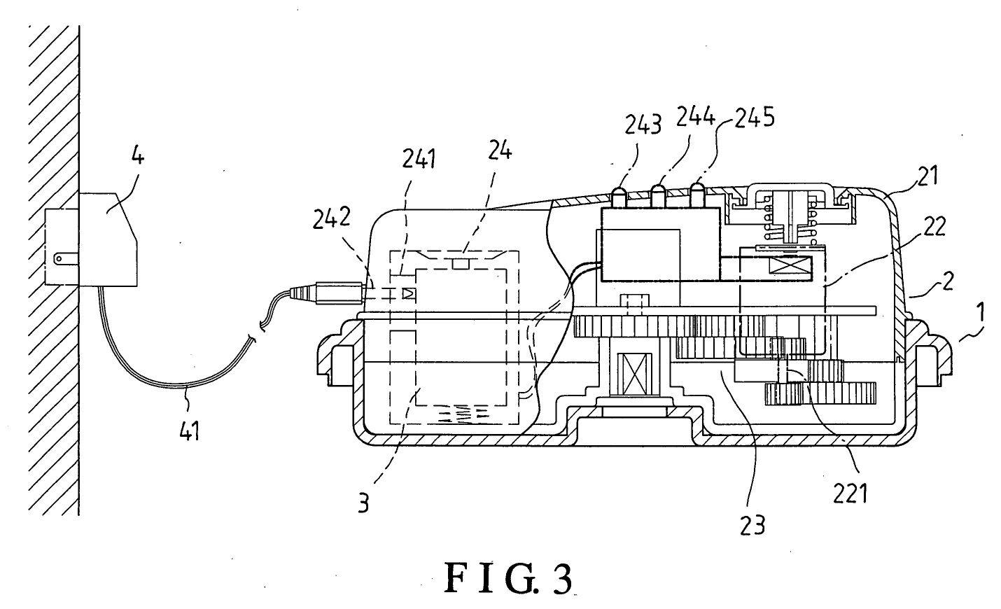

Referring to FIGS. 1 to 3, a preferred embodiment of a machine for making ice cream includes a securing seat 1, a stir mechanism 2, and a rechargeable battery 3, and a power converter 4.

The stir mechanism 2 includes a housing 21, a motor 22, a gear set 23, a control unit 24, and several blades 26, which are joined to a central shank 25. The motor 22, the gear set 23, and the control unit 24 are held in the housing 21, and the control unit 24 is electrically connected to the motor 22 to control the motor 22. An output shaft 25 of the motor 22 is connected to a first one of the gear set 23.

The rechargeable battery 3 is fitted in the control unit 24 of the stir mechanism 2 to provide power to the control unit 24. And, the control unit 24 is equipped with a charger 241, which is electrically connected to the rechargeable battery 3. The charger 241 has a socket 242 on the housing 21 for allowing the charger 241 to be connected to a power converter.

The housing 21 of the stir mechanism 2 is fitted on a recess of the securing seat 1, and the central shank 25 is inserted in the housing 21 and connected to a last one of the gear set 23 at an inner end thereof such that the blades 26 are arranged outside the housing 21, and such that the central shank 25 will rotate when the motor 22 is powered.

Furthermore, a power indicating lamp 243, a low-power indicating lamp 244, and an on-charge indicating lamp 245 are electrically connected to the control unit 24, and positioned in such as a way as to be visible from outside. The power indicating lamp 243 will be powered to produce light while the motor is running. The low-power indicating lamp 244 will be powered to produce light after a certain amount of electricity of the rechargeable battery 3 has been used. The on-charge indicating lamp 245 will be powered to produce light while the rechargeable battery 3 is being charged.

To use the machine, first the securing seat 1 is fitted over an opening of a container 5 with the central shank 25 and the blades 26 of the stir mechanism 2 being passed into the container 5, in which container 5 ice cream materials are held. Therefore, the blades 26 will move to stir the ice cream materials held in the container 5 when the motor 22 is powered. Finally, the stirred ice cream materials are put into a freezer to become ice cream.

And, the rechargeable battery 3 will be charged by means of connecting a power converter 4 to a main power supply plus connecting an output wire 41 of the power converter 4 to the socket 242 of the charger 241.

From the above description, it can be understood that the present machine for making ice cream has advantages as followings:

1. The present machine has the low-power indicating lamp 244, which will produce light to indicate that the rechargeable battery 3 needs to be charged when energy of the rechargeable battery 3 is lower than a certain level. And, the user doesn't have to change the rechargeable battery 3 when the battery 3 runs out of energy.

2. The present machine has the power indicating lamp 243, which will produce light to indicate that the machine is being used while the motor 3 is running.

3. The present machine has the on-charge indicating lamp 245, which will produce light to indicate that the rechargeable battery 3 is on charge while the rechargeable battery 3 is being charged.

What is claimed is:

1. A machine for making ice cream, comprising
(a) a stir mechanism including:
a housing;
a gear set held in the housing;
a motor held in the housing and connected to a first one of the gear set at an output shaft thereof;
a control unit held in the housing and electrically connected to the motor to control the motor; and
a plurality of blades, which are joined to a central shank; the central shank being passed into the housing and joined to a last one of the gear set at one end thereof such that the blades are outside the housing, and such that the central shank will rotate when the motor is running;
(b) a securing seat for holding the housing of the stir mechanism in position;
(c) a rechargeable battery fitted in the control unit of the stir mechanism to provide power to the control unit;
(d) a power converter having an output wire; and
(e) a charger fitted to the control unit and electrically connected to the rechargeable battery for charging the rechargeable battery with; the charger having a socket on the housing of the stir mechanism; the rechargeable battery being going to be charged when the output wire of the power converter is connected to the charger, and the power converter is connected to a wall socket.

2. The machine as claimed in claim 1, wherein a power indicating lamp is electrically connected to the control unit, and positioned in such as a way as to be visible from outside, which power indicating lamp will be powered to produce light while the motor is running.

3. The machine as claimed in claim 1, wherein a low-power indicating lamp is electrically connected to the control unit, and positioned in such as a way as to be visible from outside, which low-power indicating lamp will be powered to produce light when energy of the rechargeable battery is lower than a predetermined level.

4. The machine as claimed in claim 1, wherein an on-charge indicating lamp is electrically connected to the control unit, and positioned in such as a way as to be visible from outside, which on-charge indicating lamp will be powered to produce light while the rechargeable battery is being charged.
